(19) United States
(12) Patent Application Publication
(10) Pub. No.: US 2009/0090775 A1
(43) Pub. Date: Apr. 9, 2009

(54) Printer and issuing apparatus

(76) Inventor: Akihiko Ito, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/286,875

(22) Filed: Oct. 2, 2008

(30) Foreign Application Priority Data
Oct. 3, 2007 (JP) 2007-259932

(51) Int. Cl. B65H 29/20; G06K 15/04

(52) U.S. Cl. 235/383; 271/306

(57) ABSTRACT

Provided are a printer and an issuing apparatus in which there is no risk of causing a jam even when a user blocks a discharge port of a printed sheet, and in which occurrence of sheet jam can be effectively prevented. In a printer or an issuing apparatus having the printer built-in, a send-out means (16) formed of a pair of rollers with which a sheet is sandwiched from thereabove and therebelow to be conveyed by a rotational force is provided upstream of a discharge port (14a) for discharging the printed sheet. One roller (16a) of the pair of rollers is attached so as to be free to rotate at a leading end of a rockable arm (16c) having a rotation center downstream of a conveyance path and is biased toward another roller (16b) by its own weight or a slight spring force, and a space is provided for allowing the roller to move in a direction in which the roller is spaced apart from the other roller and for tolerating a deflection of the sheet to be transferred.

### BACKGROUND OF THE INVENTION

1. Field of the invention

The present invention relates to a technology effectively used for a printer which performs printing on a roll sheet before discharge thereof, and more particularly, to a technology effectively used for a structure of a discharge portion in which printing can be performed without causing sheet jam even in a state where a discharge port is blocked.

2. Description of the Related Art

There is provided a printer in which a roll sheet accommodated in a predetermined accommodating portion is drawn out, a desired printing is performed thereon by a thermal printer or the like, and thereafter, a printed sheet is sent out by conveying rollers to be discharged. Further, there is also provided an issuing apparatus having the printer as described above built-in, and issuing receipts, tickets, or the like.

While a discharge port for discharging the printed sheet is provided on a front surface panel of the apparatus, there is a risk that the sheet causes a jam on a conveying path when the discharge port is blocked mistakenly or intentionally. Conventionally, in order to prevent the occurrence of jam as described above, there is suggested an invention in which a space for tolerating a deflection of the sheet is willingly provided upstream of the discharge port (refer to Patent Document JP 10-119375 A, for example).

In the invention disclosed in Patent Document 1, it is possible to prevent the occurrence of jam when the sheet is deflected owing to blocking of the discharge port by hand. However, the sheet is stopped in the state where the leading end of the sheet is not protruded from the outlet of the discharge port, which leads to the risk that the sheet jam occurs.

### SUMMARY OF THE INVENTION

It is an object of the present invention to provide a printer and an issuing apparatus in which there is no risk of causing a jam even when a user blocks the discharge port of the printed sheet, and in which the occurrence of sheet jam can be effectively prevented.

### Means for Solving the Problem

In order to achieve the above-mentioned object, the present invention provides, in a printer or an issuing apparatus having the printer built-in, a send-out means formed of a pair of rollers with which the sheet is sandwiched from thereabove and therebelow to be conveyed by a rotational force is provided upstream of a discharge port for discharging the printed sheet. One roller of the pair of rollers is attached so as to be free to rotate at a leading end of a rockable arm having a rotation center downstream of a conveyance path and is biased toward another roller by its own weight or a slight spring force, and a space is provided for allowing the roller to move in a direction in which the roller is spaced apart from the other roller and for tolerating a deflection of the sheet to be transferred. In this case, the send-out means imparts a rotational driving force to the other roller facing the roller at the leading end of the rockable arm, the roller at the leading end of the arm being followingly rotated by a frictional force between the rollers and the sheet.

More specifically, in the printer including: an accommodating portion for accommodating a pre-printed sheet; a printing means for printing on the sheet drawn out of the accommodating portion; a send-out means for transferring the printed sheet to a discharge port; and a pair of conveyance plates provided between the printing means and the discharge port, for guiding the sheet to be transferred, the send-out means includes: a driving roller rotatably driven while disposed on one side of a conveyance path formed of the conveyance plates; a driven roller disposed on an opposite side of the conveyance path so as to be contactable with the driving roller, the driven roller being attached so as to be free to rotate at a leading end of a rockable arm having a rotation center downstream of the conveyance path and being biased toward the driving roller; and a window or a cutout and a space provided on a side of the conveyance plates on which the driven roller is disposed, for tolerating a deflection of the sheet to be transferred.

In the above-mentioned means, since the one roller is attached so as to be free to rotate at the leading end of the rockable arm and is biased toward the other roller, when the leading end of the sheet is stopped owing to blocking of the outlet of the discharge port, the sheet can be deflected while the roller is lifted up at a portion of the conveyance plate to which the window or the cutout is provided. Therefore, the jam and the sheet jam do not occur even when the outlet of the discharge port is blocked. Further, when the outlet of the discharge port is released thereafter, the weight of the roller being moved is applied to the roll sheet. Accordingly, a force is exerted by which the roll sheet is moved forward. As a result, when the outlet of the discharge port is released, the leading end of the roll sheet can be protruded from the discharge port, thereby preventing the sheet jam.

Further, it is desirable that the window or the cutout and the space be provided above the conveyance plates, and that the driven roller be disposed above the conveyance plates so as to be biased toward the driving roller by its own weight. The space for tolerating the deflection of the roll sheet may be provided below the conveyance path. However, with the provision thereabove, a send-out means having desired functions can be provided by the components of the minimum numbers.

Still further, it is desirable that the rotation center of the arm be set at a midpoint between the pair of conveyance plates. As a result, it is possible to generate a force by which the roll sheet is moved forward, when the outlet of the discharge port is released, by the weight of the rollers added more effectively to the roll sheet.

Yet further, it is desirable that a cutting mechanism for cutting the printed sheet to a desired length be provided between the printing means and the send-out means. Instead of providing the cutting mechanism in the printer, saw-like teeth may be provided at the outlet of the discharge port so that a user presses the sheet onto the teeth for tearing the sheet. However, with the provision of the cutting mechanism, it is possible to reduce the burden on the user and to prevent the sheet from being drawn out carelessly long.

The present invention has the following effect: a printer and an issuing apparatus can be realized in which there is no risk of causing a jam even when a user blocks the discharge port of the printed sheet, and in which the occurrence of sheet jam can be effectively prevented, whereby reduction in operation rate due to breakdown of the apparatus can be avoided, and time and cost required for repair is substantially reduced.

### BRIEF DESCRIPTION OF THE DRAWINGS

In the accompanying drawings:

FIG. 1 is a schematic structural view of a preferred embodiment of a printer to which the present invention is applied;

FIG. 2 is a side view of a more detailed structure of a send-out means of the printer of the embodiment;

FIG. 3 is a view illustrating an operation of a rockable upper roller constituting the send-out means;

FIG. 4 is a view illustrating a state in a case where only a space for tolerating the deflection of the roll sheet is provided and the upper roller is not provided; and

FIG. 5 is a perspective view of a ticket-vending machine as an example of an issuing apparatus having the printer according to the present invention built-in.

### DETAILED DESCRIPTION OF THE PREFERED EMBODIMENT

In the following, a preferred embodiment of the present invention is described with reference to the drawings.

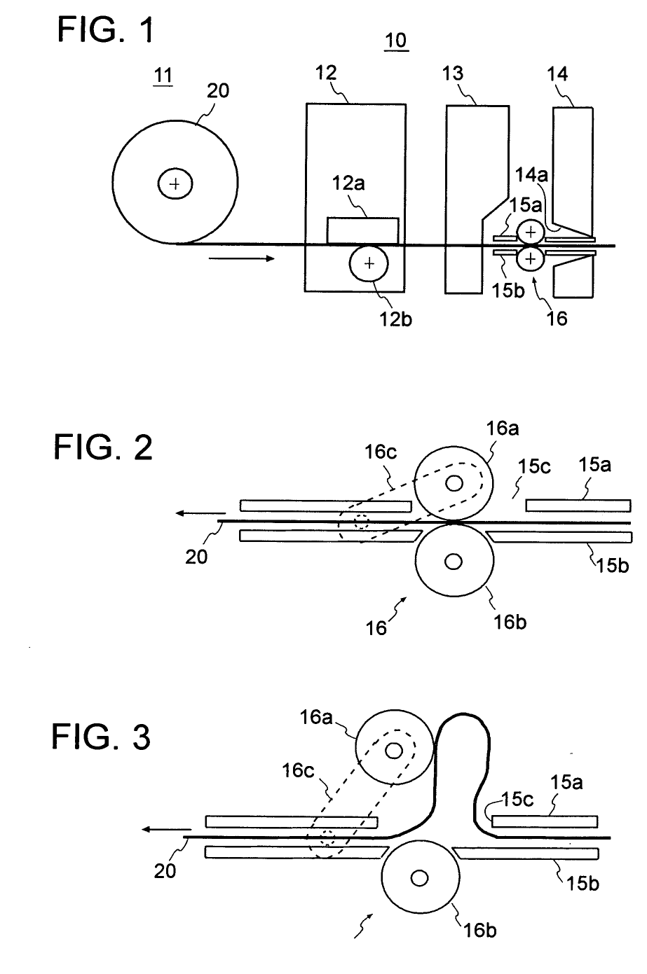

FIG. 1 is a schematic structural view of a preferred example of a printer to which the present invention is applied. A printer 10 illustrated in FIG. 1 includes an accommodating portion 11 for accommodating a roll sheet 20 obtained by winding a recording sheet such as a thermosensitive sheet into a roll shape, a thermal printer unit 12 for printing on the roll sheet drawn out of the accommodating portion 11, a cutter unit 13 as a cutting mechanism for cutting the printed sheet into a piece of sheet of a desired length, a bezel 14 as an outlet constitution member having a discharge port for discharging the cut piece of sheet to the exterior, a pair of conveyance plates 15a, 15b provided between the cutter unit 13 and the bezel 14, and a send-out means 16 formed of a plurality of pairs of rollers which are provided such that a part thereof is protruded from a window or a cutout provided to the conveyance plates 15a, 15b.

The thermal printer unit 12 includes a thermal head 12a formed of a plurality of heating elements arranged in rows, a platen roller 12b disposed such that the outer periphery thereof is brought into contact with the thermal head 12a, and a motor (not shown) for rotatably driving the platen roller 12b, in which the roll sheet is inserted between the thermal head 12a and the platen roller 12b, the platen roller 12b is rotated, and the heating elements of the thermal head are selectively heated while the roll sheet is transferred in the direction of an arrow, whereby printing on the roll sheet is performed.

The cutter unit 13 includes a cutter blade of a rotational type or a sliding type and a motor for rotating or moving the cutter blade, in which cutting of the roll sheet is performed by moving the cutter blade in the direction orthogonal to the transfer direction of the roll sheet.

The bezel 14 has a discharge port 14a which is formed to be larger upstream in opening area, that is, larger on the side facing the cutter unit 13, and to be narrower on the side of the outlet. The bezel 14 is formed of a synthetic resin or the like. The reason the discharge port 14a is formed to be larger upstream in opening area is that the leading end of the roll sheet having been transferred is facilitated to lead toward the relatively narrow outlet.

FIG. 2 illustrates a more detailed structure of the send-out means 16. Note that, in FIG. 2, illustration of the bezel 14 is omitted. Some apparatuses having the printer built-in are not provided with the bezel 14, but the discharge port of the construction similar to that of the bezel is provided on the front surface panel of the box body in some cases. In those cases, the leading ends of the conveyance plates 15a, 15b of FIG. 2 are connected to the discharge port on the front surface panel of the box body.

As illustrated in FIG. 2, the send-out means 16 is constituted by a pair of rollers 16a, 16b with which the sheet is sandwiched from thereabove and therebelow to be conveyed by a rotational force, the one roller 16a of the pair of rollers being attached so as to be free to rotate at the leading end of a rockable arm 16c having the rotation center downstream of the conveyance path and being biased toward the other roller 16b by its own weight. Further, a rotational driving force is imparted to the other roller 16b from a motor (not shown) by a gear or a belt, the roller 16a at the leading end of the arm is followingly rotated by a frictional force between the rollers and the sheet.

While FIG. 2 illustrates only the pair of rollers 16a, 16b, in the case where the width of the sheet is large, it is desirable that a plurality of pairs of rollers be disposed in the direction orthogonal to the paper surface. When a rotational driving force is transmitted to the roller 16b from a motor by a belt, the motor for rotating the platen roller 12b in the printer unit 12 can be shared therewith.

Further, on the conveyance plate 15a, a window (cutout) 15c is formed such that the arm 16c is pivotable in the direction in which the roller 16a is spaced apart from the other roller 16b. Above the window 15c, there is formed a space for tolerating, while expanded upstream of the roller 16a, the deflection of the roll sheet to be conveyed. By the presence of the space, when the roll sheet is sent out toward the discharge port in the state where the outlet of the discharge port 14a is blocked, the leading end thereof is stopped. Accordingly, the roll sheet is deflected so as to be swollen upward at the portion of the window 15c, whereby the occurrence of jam is prevented.

Further, with the provision of the roller 16a at the leading end of the rockable arm 16c having the rotation center downstream, when the roll sheet is deflected so as to be swollen upward as illustrated in FIG. 3, the roller 16a is lifted up, so the arm 16c is pivoted counterclockwise. Then, when the outlet of the discharge port 14a is released, with the application of the weight of the roller 16a to the roll sheet from thereabove, a force by which the roll sheet is moved forward is effected. As a result, when the outlet of the discharge port 14a is released, it is possible to protrude the leading end of the roll sheet from the discharge port 14a.

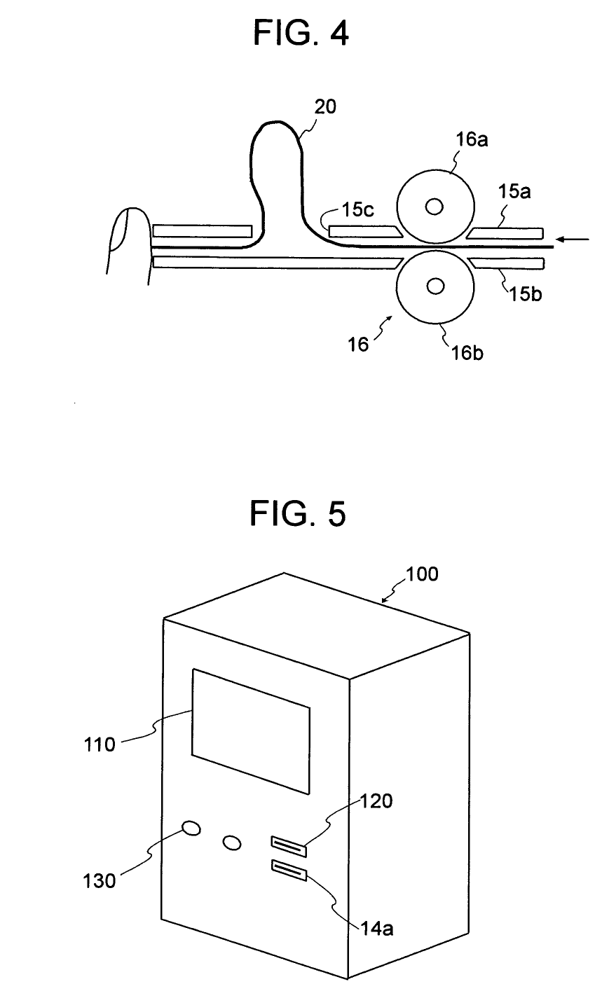

In the case where the pivotable or ascendable/descendable roller 16a is not provided, even when the outlet of the discharge port 14a is released, the leading end of the sheet is not protruded in some cases from the outlet in the state where the roll sheet remains deflected as illustrated in FIG. 4. However, by the presence of the roller 16a, it is possible to reliably protrude the leading end of the roll sheet from the discharge port 14a, thereby preventing the occurrence of sheet jam or sheet stop.

It is necessary to lift up the ascendable/descendable roller 16a when the roll sheet is deflected upward, so the weight thereof should be determined in accordance with the elasticity of the sheet. For example, in the case where the roll sheet of very low elasticity is used, it is necessary for the roller 16a to be rather small in weight. In the case where it is difficult to use the lightweight one as described above depending on the material of the roller 16a, it is possible to adjust the rotational moment by elongating the arm 16c to the opposite side with respect to the rotation center thereof, or forming the arm into a “dogleg” shape and attaching a counterweight at the leading end of the arm on the opposite side, whereby the roller 16a is pressed onto the roll sheet by a desired force.

While FIG. 2 illustrates the arm 16c whose rotation center is set downstream of the rollers 16a, 16b and at substantially the midpoint between the conveyance plates 15a, 15b in the vertical direction, the height of the rotation center is not restricted as long as the rotation center is set downstream of the rollers 16a, 16b. Note that, it is desirable that the height of the rotation center of the arm 16c be set to the position higher than the rotation center of the roller 16b and lower than the top of the roller 16a. Further, the position of the desirable height is set higher than the upper surface of the lower conveyance plates 15b and lower than the rotation center of the roller 16a.

FIG. 5 illustrates a ticket-vending machine as an example of an issuing apparatus having the printer according to the present invention built-in. An issuing apparatus 100 of FIG. 5 has the printer and a card reader built-in, and the front surface thereof is provided with a display portion 110, a card insertion/discharge port 120, the discharge port 14a for discharging tickets printed by the printer, operation buttons 130, and the like. As illustrated in FIG. 5, when the discharge port 14a is provided near the card insertion/discharge port 120, there is a risk that a user mistakenly blocks the discharge port 14a of the ticket by fingers upon reception of a card. Thus, the present invention is particularly effective when applied to the issuing apparatus as described above. Further, with the application of the present invention, it is possible to prevent the sheet jam due to prank.

While the inventions made by the inventors of the present invention have been described in detail with reference to the embodiment, it is needless to say that the present invention is not limited to the embodiment described above, and various modifications can be made without departing from the spirit of the present invention. For example, the roller 16a maybe rockable owing to the arm 16c, and an ascendable/descendable second roller or plate for pressing downward the roll sheet largely deflected upward of the window 15c may further be provided therewith.

Further, while the embodiment illustrates the printer in which the upper roller 16a is rockable owing to the arm 16c, the lower roller 16b may be rockable owing to the arm. Note that, in this case, it is necessary to provide a spring for biasing the lower roller 16b upward or to make the counterweight on the side opposite to the arm heavier than the roller 16b. In addition, while the embodiment illustrates the issuing apparatus in which a thermal printer is used as a printing means, the issuing apparatus may be applied to a printer except the thermal printer.

While the above description mainly describes an example in which the inventions made by the inventors of the present invention are applied to the ticket-vending machine which belongs to the application field providing the background thereof, the present invention is not limited thereto, but can be widely used in an ATM (automated teller machine) in the financial institution, a cash register in the store, and the other apparatuses having the printer and the card reader built-in.

What is claimed is:

1. A printer comprising:
an accommodating portion for accommodating a pre-printed sheet;
a printing means for printing on the sheet drawn out of the accommodating portion;
a send-out means for transferring the printed sheet to a discharge port; and
a pair of conveyance plates provided between the printing means and the discharge port, for guiding the sheet to be transferred,
wherein the send-out means comprises:
a driving roller rotatably driven while disposed on one side of a conveyance path formed of the conveyance plates;
a driven roller disposed on an opposite side of the conveyance path so as to be contactable with the driving roller, the driven roller being attached so as to be free to rotate at a leading end of a rockable arm having a rotation center downstream of the conveyance path and being biased toward the driving roller; and
a window or a cutout and a space provided on a side of the conveyance plates on which the driven roller is disposed, for tolerating a deflection of the sheet to be transferred.

2. A printer according to claim 1, wherein the window or the cutout and the space are provided above the conveyance plates and the driven roller is disposed above the conveyance plates so as to be biased toward the driving roller by its own weight.

3. A printer according to claim 1, wherein a rotation center of the arm is set at a midpoint between the pair of conveyance plates.

4. A printer according to claims 1, further comprising a cutting mechanism for cutting the printed sheet to a desired length, which is provided between the printing means and the send-out means.

5. A printer according to claims 1, wherein the send-out means comprises a plurality of pairs of the driving roller and the driven roller.

6. An issuing apparatus, comprising:
the printer according to claims 1;
a card reader which are built therein; and
a front surface panel on which an outlet of a discharge port for discharging the sheet printed by the printer and a card insertion/discharge port corresponding to the card reader are provided.
